(19) United States
(12) Patent Application Publication
(10) Pub. No.: US 2025/0280281 A1
(43) Pub. Date: Sep. 4, 2025

(54) COMMUNICATION APPARATUS, CONTROL METHOD, COMPUTER-READABLE STORAGE MEDIUM

(71) Applicant: CANON KABUSHIKI KAISHA, Tokyo (JP)

(72) Inventors: KAZUO MORITOMO, Kanagawa (JP); KOHTARO KOIKE, Kanagawa (JP)

(21) Appl. No.: 19/212,865

(22) Filed: May 20, 2025

Related U.S. Application Data
(63) Continuation of application No. PCT/JP2023/040025, filed on Nov. 7, 2023.

(30) Foreign Application Priority Data
Nov. 28, 2022 (JP) 2022-189531

(51) Int. Cl. H04W 8/00; G08G 1/00; H04W 76/14; H04W 88/04

(52) U.S. Cl. CPC H04W 8/005; G08G 1/22; H04W 76/14; H04W 88/04

(57) ABSTRACT

A communication apparatus that performs communication using a sidelink communication function in a 3rd Generation Partnership Project (3GPP) standard searches, by transmitting a discovery message including information indicating a predetermined function performed using the sidelink communication function, for another communication apparatus that can execute the predetermined function.

### CROSS-REFERENCE TO RELATED APPLICATIONS

This application is a Continuation of International Patent Application No. PCT/JP2023/040025, filed Nov. 7, 2023, which claims the benefit of Japanese Patent Application No. 2022-189531 filed Nov. 28, 2022, both of which are hereby incorporated by reference herein in their entirety.

### BACKGROUND

### Field of the Technology

The present disclosure relates to a communication apparatus, a control method, and a program.

### Description of the Related Art

As cellular communication standards defined by the 3rd Generation Partnership Project (3GPP®), wireless communication standards such as Long Term Evolution (LTE) and New Radio (NR) have been defined. These standards include standards (3GPP standard, TS 36.300, TS 38.300, and the like) associated with sidelink communication in which terminal apparatuses (UEs) directly communicate with each other without interposing a mobile communication network (core network).

In communication via a base station, communication between the base station and a UE is performed under the control of the base station. Therefore, communication between the UE and another UE can be performed by a communication method according to a function between the UEs under the control of the base station. On the other hand, in sidelink communication, the base station is not interposed, and it is thus assumed that processing of specifying a partner apparatus, deciding a communication method, or the like is performed between the UEs. For example, PTL 1 describes a method of performing communication using an appropriate communication method by exchanging sidelink capability information between user apparatuses. PTL 2 describes a method of connecting a UE outside the communicable range of a base station to a relay apparatus installed within the communicable range via sidelink and allowing communication with the base station. PTL 3 describes that a communication apparatus transmits a search request message to its surrounding apparatuses, and makes network settings in another apparatus selected by the user from apparatuses as the transmission sources of responses to the message.

### CITATION LIST

### Patent Literature

PTL 1: Japanese Patent Laid-Open No. 2022-071153

PTL 2: Japanese Patent Laid-Open No. 2021-078140

PTL 3: Japanese Patent Laid-Open No. 2002-236628

Sidelink communication can be used in various modes. At this time, whether it is possible to perform sidelink communication in a mode requested by a UE depends on the state of another UE as a connection destination. As in PTL 3, even if the user selects another UE as a connection destination, if the user does not know whether the other UE can execute desired sidelink communication, it is not easy to make selection appropriately. As a result, the efficiency of sidelink communication may degrade.

### SUMMARY

The present disclosure provides a technique of making it possible to efficiently execute sidelink communication.

A communication apparatus according to one aspect of the present disclosure is a communication apparatus comprises a communication unit configured to perform communication using a sidelink communication function in a 3rd Generation Partnership Project (3GPP), and a search unit configured to search means for searching, by transmitting a discovery message including information indicating a predetermined function performed using the sidelink communication function, for another communication apparatus that can execute the predetermined function after the apparatuses are connected for the sidelink communication function.

A communication apparatus according to another aspect of the present disclosure is a communication apparatus comprising: a communication unit configured to perform communication with another communication apparatus using a sidelink communication function in a 3rd Generation Partnership Project (3GPP) standard; a transmission unit configured to transmit a discovery message including information related to relay communication in order to search a relay apparatus that relays communication with the other communication apparatus; a receiving unit configured to receive, after transmission of the discovery message, a response message from the relay apparatus; and a connection processing unit configured to connect to the relay apparatus.

Features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain principles of the disclosure.

FIG. 1 is a view showing an example of the configuration of a wireless communication system.

FIG. 2 is a block diagram showing an example of the hardware configuration of a communication apparatus (UE).

FIG. 3 is a block diagram showing an example of the functional configuration of the communication apparatus (UE).

FIG. 4 is a view showing an example of the format of a message.

FIG. 5A is a table showing an example of the structure of information elements in the message.

FIG. 5B is a view showing an example of the structure of the information elements in the message.

FIG. 6 is a flowchart illustrating an example of the procedure of processing executed by a UE that transmits a discovery message.

FIG. 7 is a flowchart illustrating an example of the procedure of processing executed by a UE that receives the discovery message.

FIG. 8A is a view for explaining an operation example associated with D2D communication.

FIG. 8B is a view for explaining an operation example associated with D2D communication.

FIG. 8C is a view for explaining an operation example associated with D2D communication.

FIG. 9A is a sequence chart showing an example of the procedure of processing associated with D2D communication.

FIG. 9B is a sequence chart showing an example of the procedure of processing associated with D2D communication.

FIG. 9C is a sequence chart showing an example of the procedure of processing associated with D2D communication.

FIG. 10 is a view for explaining an operation example associated with UE Relay communication.

FIG. 11 is a sequence chart showing an example of the procedure of processing associated with UE Relay communication.

FIG. 12 is a view for explaining an operation example associated with Network Relay communication.

FIG. 13 is a sequence chart showing an example of the procedure of processing associated with Network Relay communication.

FIG. 14 is a view showing an example of the format of a message.

FIG. 15 is a table for explaining a service and its associated information stored in the message.

FIG. 16 is a flowchart illustrating an example of the procedure of processing executed by a UE on the reception side of a discovery message.

FIG. 17 is a view for explaining a use case of a system.

FIG. 18 is a sequence chart showing an example of the procedure of processing executed by the system.

FIG. 19 is a flowchart illustrating an example of the procedure of processing executed by a UE that transmits a discovery message.

FIG. 20 is a flowchart illustrating an example of the procedure of processing executed by a UE that receives the discovery message.

FIG. 21 is a view showing an example of the format of a message.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosed technique that requires all such features, and multiple such features may be combined as appropriate. Furthermore, in the attached drawings, the same reference numerals are given to the same or similar configurations, and redundant description thereof is omitted.

### First Embodiment

### System Configuration

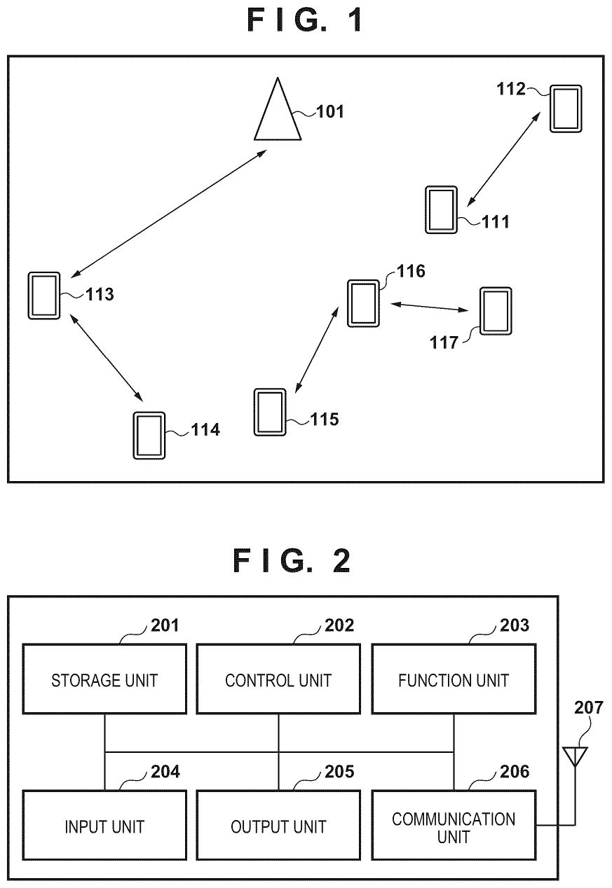

FIG. 1 shows an example of the configuration of a wireless communication system according to this embodiment. This wireless communication system is, for example, a system in which wireless communication is performed in accordance with the cellular communication standard such as LTE or NR in the 3rd Generation Partnership Project (3GPP®), and includes a base station 101 and terminals (UEs 111 to 117). The UEs 111 to 117 are configured to execute sidelink communication defined in the wireless communication standard.

The UEs 111 to 117 can perform communication in various modes using sidelink communication. For example, the UE 111 can perform direct wireless communication with the UE 112 without interposing the base station 101. In addition, for example, in 3GPP® TS 23.304, there is a standard that the UE 113 directly able to communicate with the base station 101 can relay communication between the base station and the UE 114 that cannot directly communicate with the base station 101. Furthermore, in 3GPP® technical report TR 23.752, it has been reported that a configuration in which another UE 116 relays communication between the UEs 115 and 117 that cannot directly communicate with each other is a main item to be studied. By using sidelink communication, (1) direct communication between the UEs, (2) relay between a network and the UE outside the communicable range of the base station, and (3) relay of communication between the UEs existing outside the directly communicable range can be performed. Note that (1) will sometimes be referred to as D2D communication, Network Relay, or UE Relay hereinafter.

The UE detects other UEs as candidates of a connection destination, and selects another UE as a connection destination from the candidates. Consider, for example, a case where the UE 114 existing outside the communicable range of the base station 101 attempts to perform connection to the base station 101 using Network Relay. In this case, by performing connection to the UE 113 connected to the base station 101, the UE 114 can communicate with the base station 101 via the UE 113. On the other hand, assume that, for example, the UE 114 discovers the UE 115 existing nearby as a candidate of the connection destination of sidelink communication. Assume also that the UE 115 is not connected to the base station 101, and cannot thus provide Network Relay. However, conventionally, the UE 114 can know whether the UE 115 can provide Network Relay only after establishing connection to the UE 115. As a result, the UE 114 recognizes that the UE 115 cannot provide Network Relay after performing connection to the UE 115, and then disconnects the sidelink. Then, the UE 114 needs to re-execute the processes from the processing of detecting another UE that can provide Network Relay. As described above, since the UE cannot know the status of another UE as the connection destination, the processing may become complicated. With respect to D2D communication and UE Relay as well, conventionally, the UE cannot know, in advance, whether another UE can execute such communication.

In consideration of the above problem, this embodiment provides a method of allowing a UE to specify, in advance, whether another UE as a candidate of a connection destination can execute sidelink communication in a mode requested by the self-apparatus.

In this embodiment, the UE transmits a discovery message used to detect another UE or allow another UE to detect the self-apparatus by including information indicating the mode of sidelink communication requested by the self-apparatus and additional information such as the status of communication in the self-apparatus. For example, the UE can transmit a discovery message including information indicating which communication method, among D2D communication, Network Relay, and UE Relay, is used to perform sidelink communication with the partner that is searched for. The UE may transmit a discovery message including, as information indicating the status of communication or the like, information capable of specifying whether the self-apparatus can execute D2D communication, Network Relay, and UE Relay. Note that this information may be included in a response message to respond to the discovery message. In an example, the UE that transmits a discovery message can transmit the discovery message including information indicating the requested sidelink communication method. On the other hand, the UE that transmits a response message can include, in the response message, as information indicating the status of communication, information indicating the communication method executable in the UE. Note that another UE may transmit a response message only if it can perform sidelink communication using the communication method requested by the UE. By receiving the discovery message from the UE, another UE can determine which communication method, among D2D communication, Network Relay, and UE Relay, is requested to be used. By receiving response messages from other UEs, the UE can specify another UE that can perform communication using the communication method requested by the self-apparatus. Furthermore, only the UE that can execute sidelink communication in the mode requested by the UE as the transmission source, which is indicated in the discovery message, can be caused to transmit a response message to the discovery message.

Note that the configuration and operation of a terminal (UE) that performs sidelink communication in the cellular communication standard will be described below, but the following discussion can be applied to a wireless communication apparatus that is a more generalized version of the UE and performs similar communication. Furthermore, the following configuration and operation are merely examples and arbitrary changes and modifications can be made without departing from the scope.

### Apparatus Configuration

FIG. 2 shows an example of the hardware configuration of a communication apparatus operating as a UE according to this embodiment. Note that the configuration shown in FIG. 2 is merely an example, and the UE may be implemented by a hardware configuration different from that shown in FIG. 2. For example, the UE need not include a part of the hardware configuration shown in FIG. 2 and may include additional components. The UE includes, for example, a storage unit 201, a control unit 202, a function unit 203, an input unit 204, an output unit 205, a communication unit 206, and an antenna 207.

The storage unit 201 includes a memory such as a Read Only Memory (ROM) and a Random Access Memory (RAM), and stores programs for performing various kinds of operations to be described later, and various kinds of information such as communication parameters for wireless communication. Note that other than the memory such as the ROM and the RAM, the storage unit 201 may include a storage medium such as a flexible disk, a hard disk, an optical disk, a magneto-optical disk, a CD-ROM, a CD-R, a magnetic tape, a nonvolatile memory card, or a DVD. The storage unit 201 may include a plurality of memories.

The control unit 202 is formed by, for example, a processor such as a CPU or an MPU, an Application Specific Integrated Circuit (ASIC), a Digital Signal Processor (DSP), a Field Programmable Gate Array (FPGA), or the like. Note that CPU is an acronym for Central Processing Unit, and MPU is an acronym for Micro Processing Unit. For example, the control unit 202 controls the whole UE by executing the programs stored in the storage unit 201. Note that the control unit 202 may control the UE by cooperation of the programs stored in the storage unit 201 and an OS (Operating System). The control unit 202 may include a plurality of processors such as a multi-core processor.

The control unit 202 can control the function unit 203 to implement a predetermined function such as an impact detection function, an image capturing function, a print function, or a projection function. The function unit 203 is configured to include hardware used by the UE to execute predetermined processing. For example, if the function unit 203 has the image capturing function, it includes an optical lens unit, an optical system for controlling the stop, zoom, focus, and the like, and an image sensor for converting light (video) introduced via the optical lens unit into an electrical video signal. A CMOS (Complementary Metal Oxide Semiconductor) sensor or a CCD (Charge Coupled Device) is generally used as an image sensor. Under the control of the control unit 202, the function unit 203 causes the image sensor to convert, into an electrical signal, an image of object light formed by a lens included in the function unit 203, performs noise reduction processing and the like, and outputs digital data as image data. The image data is recorded in the storage unit 201 in accordance with the DCF (Design Rule for Camera File System) standard. If the function unit 203 has the impact detection function, it includes a sensor. If the sensor detects an impact or a shake of a predetermined level or higher, the function unit 203 notifies the control unit 202 of the detection result. Note that in this embodiment, the UE can be a smartphone having an image capturing function, a digital still camera, a network camera, a printer, an in-vehicle device, or the like. However, the UE is not limited to them, and may be, for example, a projector that projects an image on a projection portion, a head mounted display that provides the user with an image based on data received from the outside, or the like. Alternatively, the UE may be a wearable device such as a smartwatch or wearable glasses having a function of projecting an image on a projection surface such as glass or the retina of the user. Note that the in-vehicle device means a standard control device incorporated in a vehicle such as an automobile, a car navigation device installed in a vehicle such as an automobile, a drive recorder device that is installed in a vehicle such as an automobile and records a video at the time of travelling, or the like.

The input unit 204 accepts various kinds of operations from the user. The output unit 205 performs various kinds of outputs to the user. In this example, the output by the output unit 205 includes at least one of display on a screen, audio output by a loudspeaker, vibration output, and the like. Note that both the input unit 204 and the output unit 205 may be implemented by one module, like a touch panel.

The communication unit 206 is configured to include hardware (a radio frequency (RF) chip, a baseband chip, or the like) for performing wireless communication complying with the 3GPP® cellular communication standard. The communication unit 206 controls the corresponding antenna 207 to transmit/receive radio signals for wireless communication. Note that FIG. 2 shows the configuration including one antenna 207 but a plurality of antennas may be used. For example, the communication unit 206 is configured to execute sidelink communication with another UE in addition to communication with the base station.

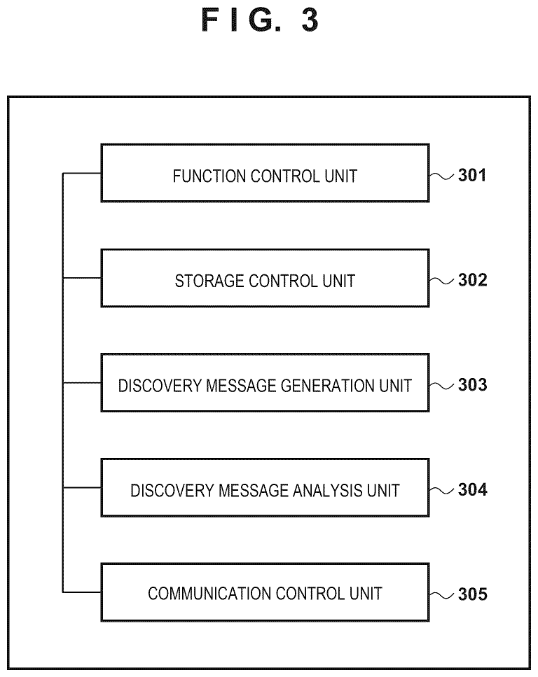

FIG. 3 is a block diagram showing an example of the functional arrangement of the communication apparatus (UE). Some (all in some cases) of the functional blocks, to be described, of the communication apparatus may be replaced by other functional blocks that implement the same functions, some functional blocks may be omitted, and further functional blocks may be added. One functional block to be described below may be divided into a plurality of functional blocks, and a plurality of functional blocks may be integrated into one functional block. The UE includes a function control unit 301, a storage control unit 302, a discovery message generation unit 303, a discovery message analysis unit 304, and a communication control unit 305. For example, the function control unit 301 controls the operation of each function of the UE by causing the control unit 202 to execute the program stored in the storage unit 201. For example, the storage control unit 302 executes various kinds of control operations associated with storage of information such as storage of information in the storage unit 201 and extraction of information from the storage unit 201. The discovery message generation unit 303 generates a discovery message to be sent to detect another UE. In some cases, the discovery message generation unit 303 generates a response message to a discovery message received from another UE. The discovery message analysis unit 304 analyzes a discovery message sent from another UE. The communication control unit 305 executes control of the communication unit 206 to execute communication with the base station or sidelink communication with another UE. Note that the communication control unit 305 is configured to send the discovery message generated by the discovery message generation unit 303 or supply, to the discovery message analysis unit 304, the discovery message sent from another UE and received.

### Structure of Discovery Message

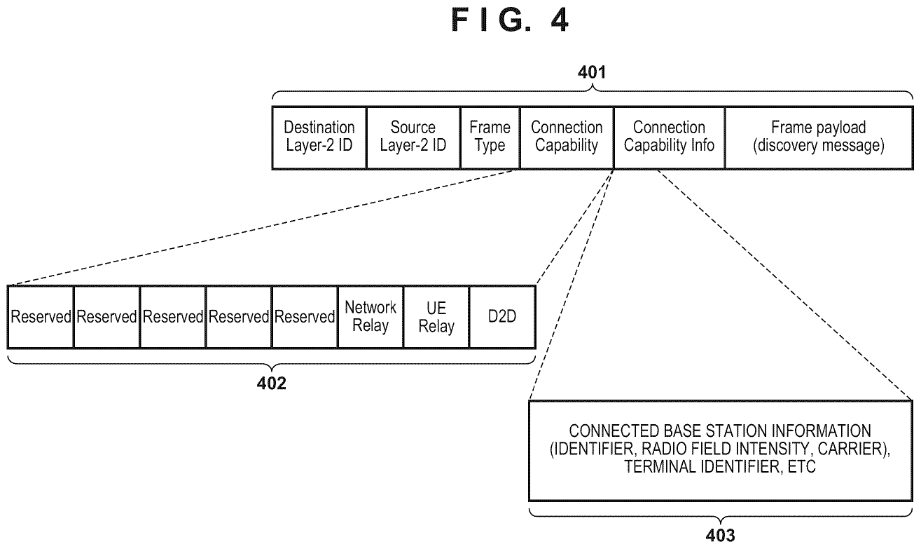

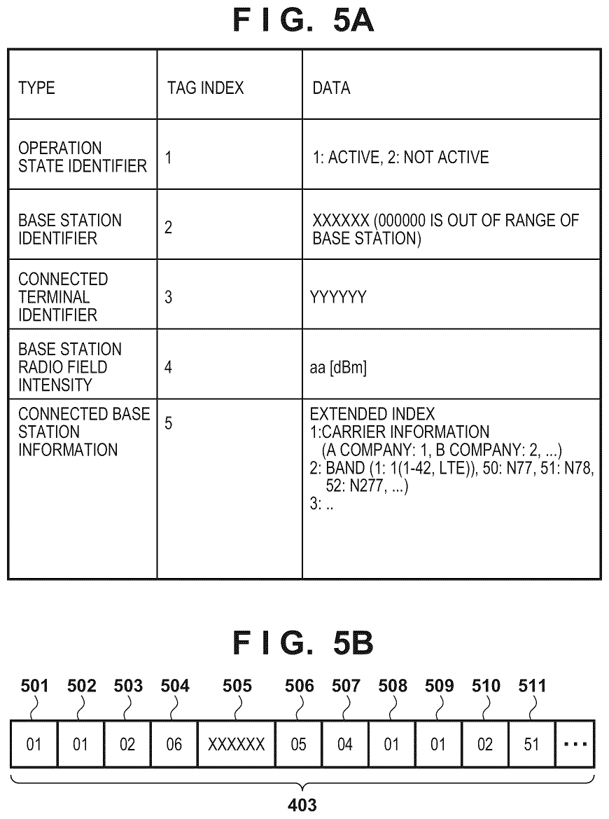

Subsequently, an example of the structure of the discovery message and the response message will be described with reference to FIGS. 4, 5A, and 5B. FIG. 4 shows the exemplary format of the discovery message and the response message. Note that the discovery message will be described below but the response message can include the same contents unless otherwise specified. Note that the discovery message is a message that is transmitted when the UE performs detection processing of other UEs, and the response message is a message for allowing another UE that has received the discovery message to detect the presence of the self-apparatus. This embodiment assumes that the discovery message and the response message used for the 5G ProSe Direct Discovery procedure have the format shown in FIGS. 4, 5A, and 5B. Each message is used to discover another adjacent UE that supports 5G ProSe by direct wireless transmission between two UEs using the 5G NR (New Radio) technology. Note that ProSe is an abbreviation for Proximity Service.

In a message 401, a Destination Layer-2 ID field stores a Layer-2 ID indicating the destination of the message. In an example, in the Destination Layer-2 ID field of the discovery message, not information indicating another individual UE as the destination but, for example, information indicating broadcast can be set. On the other hand, in the Destination Layer-2 ID field of the response message, the ID of the UE as the transmission source of the discovery message can be set. A Source Layer-2 ID field stores a Layer-2 ID indicating the transmission source of the message. A Frame type field stores information indicating the type of the message. For example, information indicating whether the message is the discovery message or the response message is stored in the Frame type field. In the Frame type field of the discovery message, “Prose Direct Discovery” is set.

In a Connection Capability field 402, information indicating the mode of Side link communication requested by the UE (the UE that performs detection processing of other UEs) as the transmission source of the discovery message 401 is set. For example, as shown in FIG. 4, as the information indicating the mode of Side link communication, bits for setting “Network Relay”, “UE Relay”, and “D2D” as the sidelink communication methods can be prepared. The bit corresponding to the communication method requested by the UE as the transmission source of the discovery message, among those communication methods, is set to “1”, and the bits corresponding to the communication methods that are not requested are set to “0”. Note that this is merely an example, and a bit corresponding to a mode other than those communication methods may be prepared, or the bit corresponding to the requested mode may be set to “0” and the bits corresponding to the modes that are not requested may be set to “1”. Note that if the UE wants to obtain all pieces of information of other UEs on the periphery of the self-apparatus, nothing needs to be set in the Connection Capability field (for example, all bits are set to “0”).

Note that if another UE receives the discovery message in which nothing is set in the Connection Capability field 402, it can return the response message in which the sidelink communication method executable by the self-apparatus is set. Note that if another UE receives the discovery message, it transmits the response message in which the ID of the UE as the transmission source of the discovery message is designated in the Destination Layer-2 ID field. In this case, the sidelink communication method executable by the UE that transmits the response message can be set in the Connection Capability field 402 of the response message. For example, the bit corresponding to the sidelink communication method executable by the UE can be set to “1”, and the bit corresponding to the sidelink communication method inexecutable by the UE can be set to “0”. Note that “0” may indicate the executable sidelink communication method and “1” may indicate the inexecutable sidelink communication method. If the UE can execute a plurality of communication methods, it can set each of the bits corresponding to the plurality of methods to a value indicating that the method is executable. On the other hand, upon receiving the discovery message in which the requested communication method is designated, the UE can return the similar response message in a case where it can execute sidelink communication by the requested communication method. Note that in this case, nothing needs to be set in the Connection Capability field 402 of the response message. In this case, in accordance with reception of the response message in which the ID of the self-apparatus is designated in the Destination Layer-2 ID field, the UE that has transmitted the discovery message can estimate to be able to execute sidelink communication by the requested communication method. Note that in a case where sidelink communication is inexecutable by the requested communication method designated in the discovery message, the UE returns no response message.

In a Connection Capability Info field 403, necessary information is set in accordance with the executable sidelink communication method. For example, information indicating an identifier and a carrier associated with the base station to which the UE that transmits the message is currently connected, base station information such as the received radio field intensity of a signal from the base station, the terminal identifier of the UE, and the like are stored in the Connection Capability Info field 403. The identifier associated with the base station can be, for example, a physical cell identifier. The information indicating a carrier may be information capable of specifying a network, such as a Public Land Mobile Network (PLMN) identifier. The information indicating a carrier may be, for example, information capable of specifying a use frequency band, such as Absolute Radio Frequency Channel Number (ARFCN). The carrier information may be information of a communication carrier that operates the base station. Note that the base station information may be formed to include at least one of the above-described identifier, carrier (use frequency band/communication carrier) information, and received radio field intensity. In addition to or instead of this, other information may be included. The terminal identifier can be, for example, an identifier such as Temporary Mobile Subscriber Identities (TMSI) associated with communication with the base station. Alternatively, the terminal identifier may be another arbitrary identifier capable of specifying the UE. Note that these pieces of information are merely examples. For example, as information associated with UE Relay, information capable of specifying another connected UE may be set in the Connection Capability Info field 403.

Examples of the pieces of information set in the Connection Capability Info field 403 will be described with reference to FIGS. 5A and 5B. FIG. 5A shows examples of information items set in the Connection Capability Info field 403. As an example, an operation state identifier, a base station identifier, a connected terminal identifier, a base station radio field intensity, connected base station information, and the like are set in the Connection Capability Info field 403. Each of these pieces of information is added with an index of 1 to 5, and the index is used in the Connection Capability Info field 403 to declare which of the pieces of information is to be transmitted. For example, when “01” is set in an item 501 of FIG. 5B, it is designated that the operation state identifier follows in a subsequent item 502. In this case, for example, “01” indicating that a function of executing Network Relay is active is set in the item 502. Note that whether the function is active is specified separately from information indicating whether the function is supported. That is, in a case where the Network Relay function is supported but is not active, corresponding information in the Connection Capability field can be set to “01” and the operation state identifier can be set to “02”. The base station identifier is described in a subsequent item 503. The base station identifier may have, for example, a fixed length but may have a variable length. If variable-length information is used, for example, the length of the information is indicated in an item 504 like “06”, and the base station identifier “XXXXXX” is set in a subsequent item 505. Furthermore, “05” indicating the connected base station information is set in an item 506, and the length of the information is indicated as “04” in an item 507. The connected base station information is formed to represent further information by an extended index. For example, “01” is set in an item 508, and “01” indicating that the UE as the transmission source of the message is connected to the base station of company A is set in a subsequent item 509. In addition, “02” is set in an item 510, and “51” indicating that a frequency band in use is n78 is set in a subsequent item 511. Note that these pieces of information are merely examples, and information of another form may be set in the Connection Capability Info field 403.

Referring back to FIG. 4, a Frame Payload field stores the main body of information exchanged between the apparatuses using the message.

### Procedure of Processing

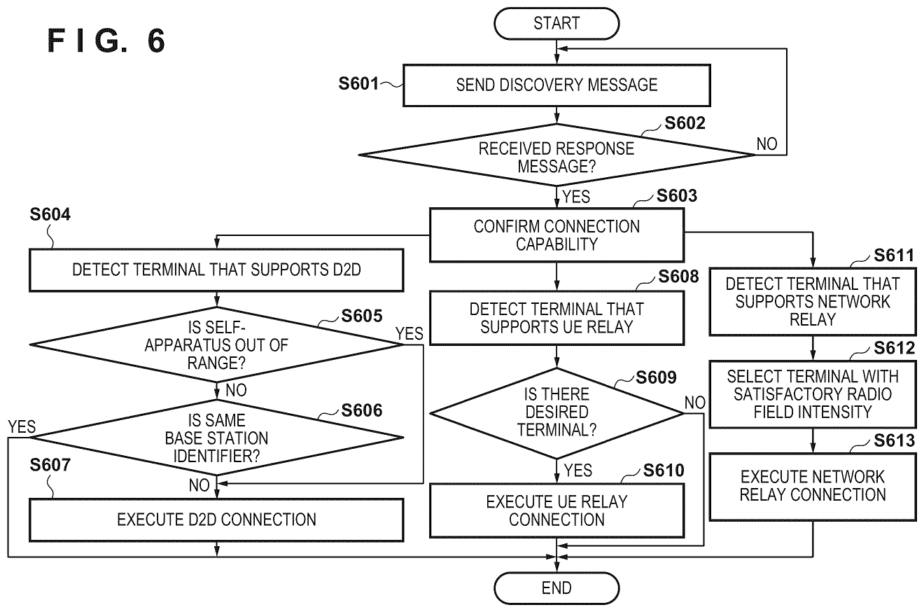

An example of the procedure of processing executed by the UE that transmits the discovery message will be described with reference to FIG. 6. Note that this processing is executed using, for example, the discovery message generation unit 303. The processing shown in FIG. 6 is merely an example. For example, some processing steps may be omitted and processing steps not shown in FIG. 6 may be added.

First, the UE generates the discovery message as described above, and sends it to the periphery of the UE (step S601). In an example, if the UE obtains all pieces of information of UEs around itself, the UE sets nothing in the Connection Capability field, and sends the discovery message. If, for example, the UE detects only another UE that can execute D2D communication (supports the D2D communication function), the UE sets the bit corresponding to D2D communication to a predetermined value in the Connection Capability field. Similarly, if the UE detects another UE that can execute UE Relay or Network Relay, the UE sets the corresponding bit in the Connection Capability field to a predetermined value. Note that the UE can set, to a predetermined value, the bit corresponding to the second communication method requested to be used, among one or more first communication methods supported by the self-apparatus. That is, it is possible to prevent the UE from setting the corresponding bit to the predetermined value with respect to the communication method that is not supported by the self-apparatus. After that, the UE waits for reception of the response message from another UE (step S602). Upon receiving the response message from another UE, the UE confirms the value of the Connection Capability field in the message (step S603). As described above, the Connection Capability field in the response message stores information indicating which of D2D communication, UE Relay, and Network Relay can be executed by the other UE as the transmission source of the response message. Therefore, by analyzing the Connection Capability field, the UE can specify which of the communication methods can be used by the other UE as the transmission source of the response message to execute sidelink communication.

For example, processing in a case where the UE desires to perform D2D communication with another UE will now be described. The UE confirms that another UE that can execute D2D communication exists on the periphery (step S604). Note that if there is no other UE that can execute D2D communication on the periphery, the UE may directly end the processing. If a UE that can execute D2D communication exists on the periphery, the UE determines whether to execute D2D communication with the peripheral UE. For example, if both the UE and the peripheral UE are connected to the same base station, the UE may be able to execute high-speed communication by performing communication via the base station without performing D2D communication. This case includes, for example, a case where the frequency band used for the connection to the base station is a frequency band such as the millimeter wave band in which a sufficiently wide signal bandwidth can be ensured and a large amount of resources can be used. Therefore, in this embodiment, if the UE is currently connected to the same base station as that of the other UE, it is determined not to perform D2D communication.

If the UE is not in the communicable range of any of the base stations (YES in step S605), the UE is not connected to the same base station as that of the peripheral UE, and thus executes D2D communication (step S607). Alternatively, if the UE is currently connected to any of the base stations (or located in the cell provided by the base station), the UE confirms the Connection Capability Info field in the response message. Then, the UE obtains the identifier of the base station to which the other UE that has transmitted the response message is currently connected (or located), and determines whether the other UE exists within the communicable range of the same base station as that of the self-apparatus (step S606). Then, if the UE and the other UE exist within the communicable range of the same base station (YES in step S606), the UE does not perform D2D communication; otherwise (NO in step S606), the UE performs D2D communication (step S607). Note that if, for example, the frequency band used by the base station to which the UE is currently connected (or located) is not a predetermined frequency band such as the millimeter wave band, even if the other UE is currently connected (located) to the same base station, the UE may determine to perform D2D communication. Alternatively, if, for example, radio quality with the base station to which the self-apparatus and the other UE are currently connected (located) is lower than a predetermined value, the UE may determine to perform D2D communication. Even if the UE is connected to the base station different from that of the other UE, if each of the self-apparatus and the other UE can perform large-capacity communication with the base station, the UE may determine not to perform D2D communication. As described above, whether to perform D2D communication can be determined based on various criteria, and this is not limited to the above-described determination processing based on whether the UEs are connected to the same base station.

Next, for example, processing in a case where the UE desires another UE to relay, by UE Relay communication, communication with a communication partner UE will be described. The UE confirms the Connection Capability field in the received response frame, thereby confirming that another UE that can execute UE Relay communication exists on the periphery (step S608). In an example, a UE that establishes connection to another UE by sidelink communication or a UE belonging to a group including another UE for executing sidelink communication transmits the response frame indicating that UE Relay communication is executable. If there is no such other UE, the UE directly ends the processing. On the other hand, if there is another such UE on the periphery, the UE analyzes the Connection Capability Info field in the response frame transmitted from the other UE. Then, the UE determines whether, among other UEs as the transmission sources of the response frames, there is another UE that can perform sidelink communication with the communication partner UE of the self-apparatus (step S609). Then, if there is another UE that can perform sidelink communication with the communication partner UE on the periphery (YES in step S609), the UE establishes connection to the other UE, and executes UE Relay communication using sidelink communication (step S610). On the other hand, if there is no other UE that can execute sidelink communication with the communication partner UE on the periphery (NO in step S609), the UE directly ends the processing (step S610).

Finally, for example, processing in a case where the UE desires another UE to relay, by Network Relay communication, communication with the base station will be described. The UE confirms the Connection Capability field in the received response frame, thereby confirming that another UE that can execute UE Relay communication exists on the periphery (step S611). Then, the UE analyzes the Connection Capability Info field in the response frame transmitted from such another UE. The Connection Capability Info field stores, for example, information such as the identifier of the base station as the connection destination, the received radio field intensity from the base station, a carrier that operates the base station, and a frequency band used for communication. Based on these pieces of information, the UE decides which of other UEs that can execute Network Relay communication is to be connected. Assume that the UE focuses on that radio quality with the base station is satisfactory, and selects, as the connection destination, another UE in which the received radio intensity from the base station is satisfactory (step S612). Note that this is merely an example, and the UE may permit, for example, only another UE that is connected to a specific carrier (for example, a carrier with which the self-apparatus has contracted) to perform connection. Alternatively, for example, the UE may decide to be preferentially connected to another UE that is connected to the base station from which the received radio intensity equal to or higher than a predetermined value is obtained and which uses a high-frequency band in which broadband transmission is possible. The UE may select another UE as the connection destination in accordance with the priority order obtained by inputting the information stored in the Connection Capability Info field to a predetermined function. After that, the UE is connected to the other selected UE to execute Network Relay communication (step S613). Note that another UE may be in a state in which it is currently connected to the base station or in a waiting state. If another UE is in the waiting state, when the UE receives a connection request for Network Relay communication, the UE may establish connection to the base station in the waiting state.

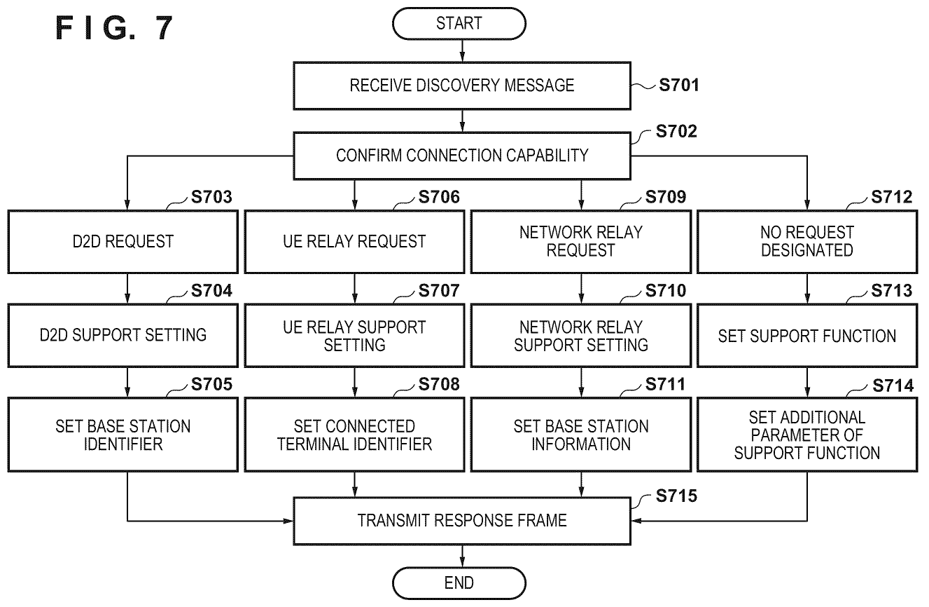

Subsequently, an example of the procedure of processing executed by the UE that receives the discovery message and returns the response message will be described with reference to FIG. 7. Note that this processing is executed using, for example, the discovery message analysis unit 304. The processing shown in FIG. 7 is merely an example. For example, some processing steps may be omitted and processing steps not shown in FIG. 7 may be added.

Upon receiving the discovery message sent from another UE on the periphery (step S701), the UE analyzes the Connection Capability field included in the message, and confirms the sidelink communication method requested by the other UE (step S702).

If the other UE requests D2D communication (step S703), the UE includes, in the Connection Capability field of the response message, information indicating whether the self-apparatus can execute (support) D2D communication (step S704). For example, if the self-apparatus supports D2D communication, the UE sets, to “1”, the bit corresponding to D2D communication in the Connection Capability field. Similarly, if the other UE requests UE Relay communication (step S706), the UE includes, in the Connection Capability field of the response message, information indicating whether the self-apparatus supports UE Relay communication (step S707). If the other UE requests Network Relay communication (step S709), the UE includes, in the Connection Capability field of the response message, information indicating whether the self-apparatus supports Network Relay communication (step S710). Furthermore, if the UE receives, from another UE, the discovery message in which any specific sidelink communication method is not designated (step S712), the UE includes the function supported by the self-apparatus in the Connection Capability field of the response message (step S713).

In addition, the UE includes, in the Connection Capability Info field, additional information associated with the supported communication method indicated in the Connection Capability field (step S705, S708, S711, or S714). For example, if the UE includes, in the response message, information indicating that the self-apparatus supports D2D communication, the UE sets, in the Connection Capability Info field, the base station identifier associated with the base station to which the UE is currently connected or located (step S705). If the UE includes, in the response message, information indicating that the self-apparatus supports UE Relay communication, the UE sets, in the Connection Capability Info field, the terminal identifier capable of specifying another connected UE (step S708). If the UE includes, in the response message, information indicating that the self-apparatus supports Network Relay communication, the UE sets, in the Connection Capability Info field, the base station information concerning the base station to which the UE is currently connected or located (step S711). Note that the base station information includes, for example, a base station identifier, received radio field intensity, carrier information, a band, and the like. If the UE receives the discovery message in which any specific sidelink communication method is not designated, the UE sets, in the Connection Capability Info field, all pieces of additional information concerning the function supported by the self-apparatus (step S714). Note that the UE can generate one response message including the pieces of information concerning the plurality of communication methods and transmit the message, but may generate an individual response message for each communication method and transmit it.

### Operation Examples

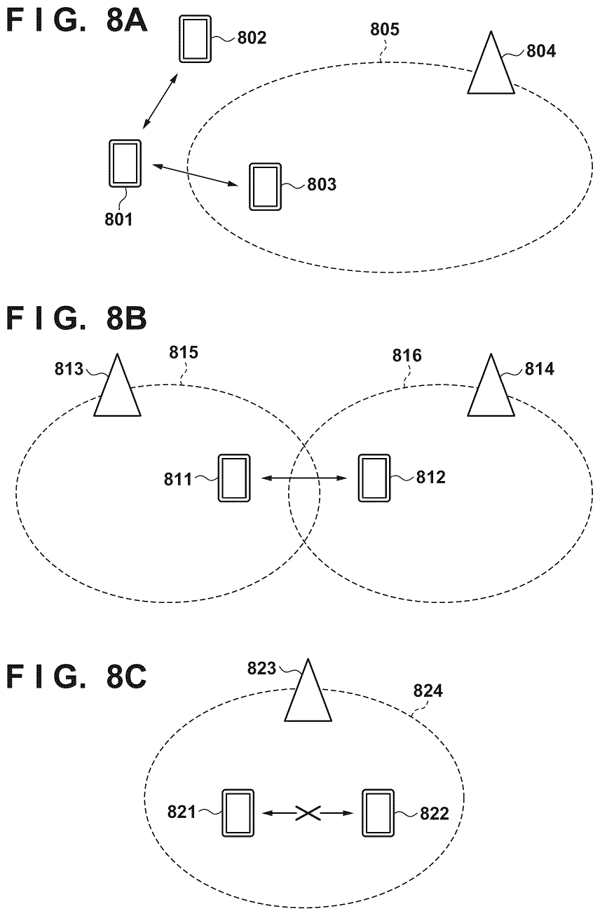

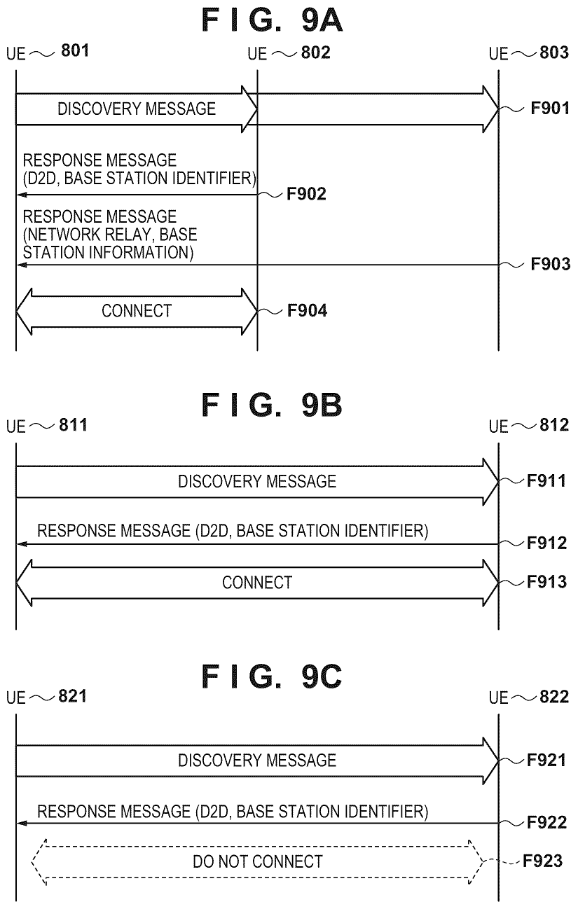

Subsequently, some operation examples in the above-described system will be described. First, an example of processing in a case where the UE requests D2D communication will be described. FIGS. 8A to 8C show some situations in which D2D communication is requested. FIGS. 9A to 9C each show an example of the procedure of processing in each situation. For example, D2D communication can be used by vehicles each including the UE with the sidelink communication function to exchange information between the vehicles to perform platooning. When such vehicle exchanges information concerning road information by directly communicating with road-installed equipment (a traffic signal or the like) including the UE with the sidelink communication function, D2D communication can also be used.

In FIG. 8A, for example, a UE 801 is to execute D2D communication. In this example, UEs 802 and 803 exist on the periphery of the UE 801. The UE 803 is within the range of a cell 805 formed by a base station 804, and can communicate with the base station 804. In this state, the UE 801 transmits, to its periphery, a discovery message without designating any specific communication method in the Connection Capability field, and the UEs 802 and 803 each receive the message (F901). In response to the discovery message, the UE 802 transmits, to the UE 801, a response message in which values indicating that D2D communication is possible and the UE is not located in any of the ranges of base stations are set (F902). The UE 803 sets information indicating that Network Relay communication is possible and base station information concerning the base station 804 and transmits the response message to the UE 801 (F903). In this case, the UE 801 desires D2D communication, and thus determines whether to perform D2D communication with the UE 802 as a communication partner. If the example of the processing shown in FIG. 6 is used, since the self-apparatus does not exist within the communicable range of any of the base stations (YES in step S605), the UE 801 determines to perform D2D communication with the UE 802, thereby executing connection processing (F904). Note that each of the UEs 802 and 803 may include, in additional information, information indicating whether the supported communication function is active. This allows the UE 801 to specify whether it is possible to immediately start communication by the communication function supported by each UE.

In FIG. 8B, for example, a UE 811 is to execute D2D communication. A UE 812 exists on the periphery of the UE 811. The UE 811 is within the range of a cell 815 formed by a base station 813, and can communicate with the base station 813. In addition, the UE 812 is within the range of a cell 816 formed by a base station 814, and can communicate with the base station 814. In this state, the UE 811 transmits, to its periphery, a discovery message without designating any specific communication method in the Connection Capability field, and the UE 812 receives the message (F911). In response to the discovery message, the UE 812 transmits, to the UE 811, a response message in which values indicating that D2D communication is possible and the UE is located in the range of the base station 814 are set (F912). Thus, the UE 811 recognizes that it can execute D2D communication with the UE 812, and determines whether to perform D2D communication with the UE 812 as a communication partner. If the example of the processing shown in FIG. 6 is used, since the self-apparatus exists within the communicable range of the base station 813 and the UE 812 exists within the communicable range of the base station 815 different from the base station 813 (NO in step S606), the UE 811 determines to perform D2D communication with the UE 812. Then, the UE 811 executes connection processing to the UE 812 (F913). Note that the UE 812 may include, in additional information, information indicating whether the supported D2D communication function is active. This allows the UE 811 to specify whether it is possible to immediately start D2D communication.

In FIG. 8C, for example, a UE 821 is to execute D2D communication. A UE 822 exists on the periphery of the UE 821. In addition, both the UEs 821 and 822 are within the range of a cell 824 formed by a base station 823, and can communicate with the base station 823. In this state, the UE 821 transmits, to its periphery, a discovery message without designating any specific communication method in the Connection Capability field, and the UE 822 receives the message (F921). In response to the discovery message, the UE 822 transmits, to the UE 821, a response message in which values indicating that D2D communication is possible and the UE is located in the range of the base station 823 are set (F922). Thus, the UE 821 recognizes that it can execute D2D communication with the UE 822, and determines whether to perform D2D communication with the UE 822 as a communication partner. If the example of the processing shown in FIG. 6 is used, since the self-apparatus exists within the communicable range of the base station 823 and the UE 822 also exists within the communicable range of the same base station 823 (YES in step S606), and thus the UE 821 determines not to perform D2D communication with the UE 822. Then, the UE 821 does not execute connection processing to the UE 822 (F923), and performs, for example, communication via the base station 823.

As described above, the UE can readily specify another UE that can execute D2D communication, and can execute D2D communication with the other UE. In addition, based on the additional information included in the response message, the UE can appropriately determine whether to execute D2D communication, for example, the UE can determine not to perform D2D communication with another UE connected to the same base station.

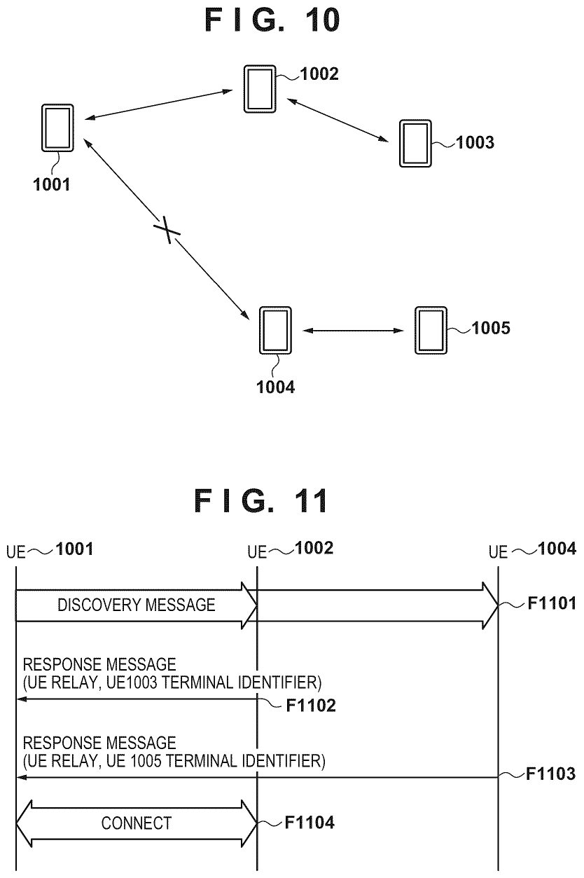

An example of processing in a case where the UE requests first another UE supporting the UE Relay communication function to relay communication with second another UE will be described next. FIG. 10 shows a situation in which UE Relay communication is requested, and FIG. 11 shows an example of the procedure of processing in this situation. Note that UE Relay can be used when vehicles each including the UE with the sidelink communication function outside the communicable range of the base station exchange road information between the vehicles using UE Relay. When road-installed equipment (a traffic signal or the like) including the UE with the sidelink communication function supports UE Relay, it is possible to support communication between vehicles each including the UE with the sidelink communication function outside the communicable range of the base station.

In FIG. 10, a UE 1001 is to communicate with a UE 1003. UEs 1002 and 1004 exist on the periphery of the UE 1001, and the UE 1003 and a UE 1005 exist within a range where the UE 1001 cannot be connected directly. Note that the UE 1002 can directly communicate with the UE 1003, and the UE 1004 can directly communicate with the UE 1005. Assume that the UEs 1002 and 1004 support UE Relay communication.

To search for another UE that can relay, using the UE Relay communication function, communication with the UE 1003, the UE 1001 transmits a discovery message in which UE Relay is set in the Connection Capability field (F1101). Upon receiving the discovery message, each of the UEs 1002 and 1004 transmits, to the UE 1001, the response message indicating that the self-apparatus supports the UE Relay communication function (F1102 and F1103). Note that the UE 1002 can include the terminal identifier of the UE 1003 as additional information in the Connection Capability Info field of the response message. The UE 1004 can include the terminal identifier of the UE 1005 as additional information in the Connection Capability Info field of the response message. Upon receiving the response messages, the UE 1001 can specify that it can communicate with the UE 1003 by UE Relay communication of the UE 1002 and it can communicate with the UE 1005 by UE Relay communication of the UE 1004. Then, the UE 1001 desires to communicate with the UE 1003, and thus selects, as the connection destination, the UE 1002 that can communicate with the UE 1003 by UE Relay communication, thereby executing connection establishment processing (F1104). Note that each of the UEs 1002 and 1004 may include, in the additional information, information indicating whether the supported UE Relay communication function is active. This allows the UE 1001 to specify whether it is possible to immediately start communication with a desired partner apparatus by the UE Relay communication function.

As described above, the UE can readily specify another UE that can execute UE Relay communication, and can receive provision of UE Relay communication by the other UE. Note that based on the additional information included in the response message, the UE can appropriately select another UE that allows communication with an appropriate partner apparatus. Thus, the UE can appropriately select another apparatus supporting the UE Relay communication function, thereby performing communication with a desired partner apparatus.

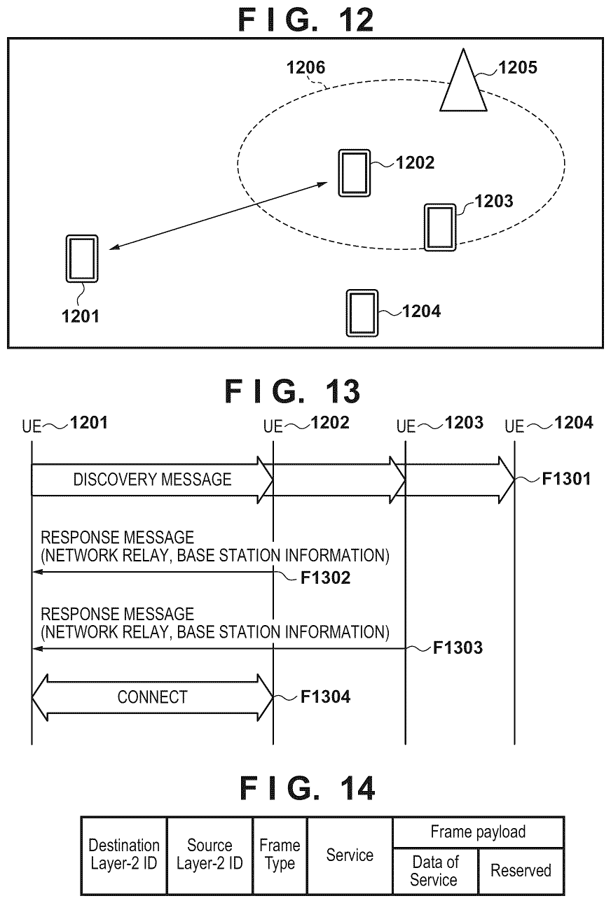

An example of processing in a case where the UE requests first another UE supporting the Network Relay communication function to relay communication with second another UE will be described next. FIG. 12 shows a situation in which Network Relay communication is requested, and FIG. 13 shows an example of the procedure of processing in this situation. The Network Relay function can be used to, for example, extend the communicable range of a base station. A vehicle including the UE with the sidelink communication function and existing outside the communicable range of the base station can be connected to the base station by relay of communication of road-installed equipment including the UE with the sidelink communication function and supporting the Network Relay function. Thus, a vehicle existing outside the communicable range of the base station can access the Internet and the like to obtain road information and the like.

In FIG. 12, a UE 1201 searches for another UE supporting the Network Relay function to perform connection to a base station. UEs 1202, 1203, and 1204 exist on the periphery of the UE 1201. The UEs 1202 and 1203 exist within a communicable range 1206 of a base station 1205, and support Network Relay. On the other hand, the UE 1204 exists outside the communicable range 1206, and does not support Network Relay. The radio field intensity in the UE 1202 from the base station 1205 is higher than that in the UE 1203 from the base station 1205.

To search for another UE supporting the Network Relay communication function, the UE 1201 transmits a discovery message in which Network Relay is set in the Connection Capability field (F1301). Since each of the UEs 1202 and 1203 supports the Network Relay function, the UE returns, to the UE 1201, the response message including information indicating that the self-apparatus supports the Network Relay function (F1302 and F1303). Note that each of the UEs 1202 and 1203 transmits the response message including additional information such as the base station identifier of the base station 1205 to which the UE is currently connected or located, the received radio field intensity, carrier information, and use frequency band. Note that each of the UEs 1202 and 1203 can include, in the additional information, information indicating whether the supported Network Relay function is active. This allows the UE 1201 to determine whether it is possible to immediately start communication with the base station by the Network Relay function. On the other hand, the UE 1204 does not support the Network Relay function, and thus returns no response message.

Upon receiving the response message from each of the UEs 1202 and 1203, the UE 1201 can specify that each of the UEs 1202 and 1203 supports the Network Relay function. Then, the UE 1201 specifies, from each response message, information of the base station to which each of the UEs 1202 and 1203 is connected and, for example, selects, as the connection destination, the UE 1202 in which the received radio field intensity is satisfactory, thereby executing connection processing to the UE 1202 (F1304).

As described above, the UE can readily specify another UE that can execute Network Relay communication, and can receive provision of Network Relay communication by the other UE. Note that based on the additional information included in the response message, for example, the UE can appropriately select another UE that allows communication with the base station with more satisfactory radio quality. Thus, the UE can appropriately select another apparatus supporting the Network Relay communication function, thereby performing communication with the base station.

In the above-described embodiment, a method in which the UE that has received a discovery message returns a response message in which a supported communication method is set has been described. However, the present disclosure is not limited to this. For example, the UE may periodically send a signal such as a notification signal in which a supported communication method is set even if the UE does not receive a discovery message. In an environment in which such signals are transmitted, by detecting the signals sent by other UEs on the periphery, the UE can readily specify another UE that can execute sidelink communication by a communication method requested by the self-apparatus.

### Second Embodiment

The above-described embodiment has explained a method in which a UE can specify, on its periphery, another UE that can execute a sidelink communication by a communication method requested by the self-apparatus. This embodiment provides a method in which a UE specifies another UE that can provide a service requested by the self-apparatus and can execute sidelink communication, and executes the service. Note that an apparatus configuration is the same as in the first embodiment.

In this embodiment, a discovery message in a format shown in FIG. 14 is used. In this format, a Destination Layer-2 ID field, Source Layer-2 ID field, and a Frame type field are the same as those described with reference to FIG. 4. That is, this embodiment assumes that a discovery message used for the 5G ProSe Direct Discovery procedure has the format shown FIG. 14. The discovery message used in this embodiment includes a “Service” field after the Frame type field. The Service field stores information indicating a service that is requested, by the UE as the transmission source of the discovery message, to be executed by another UE. A Frame Payload field stores information corresponding to the Service field. In this embodiment, the UE can generate a discovery message in which, for example, “Recording” is stored in the Service field and position information obtained by the self-apparatus is stored in the Frame Payload field, and transmit the discovery message. Upon receiving the discovery message, a UE can generate a response frame using the format shown in FIG. 14 and return the response frame, as needed. In an example, upon receiving the discovery message, a UE returns a response frame in which information indicating the service executable by the self-apparatus (the service requested by the UE that has transmitted the discovery message) is stored in the Service field. In addition, the UE can store information corresponding to the service in the Frame Payload field of the response frame. That is, in this embodiment, information indicating the service executable by the self-apparatus is stored in the response frame of the discovery message used for the 5G ProSe Direct Discovery procedure.

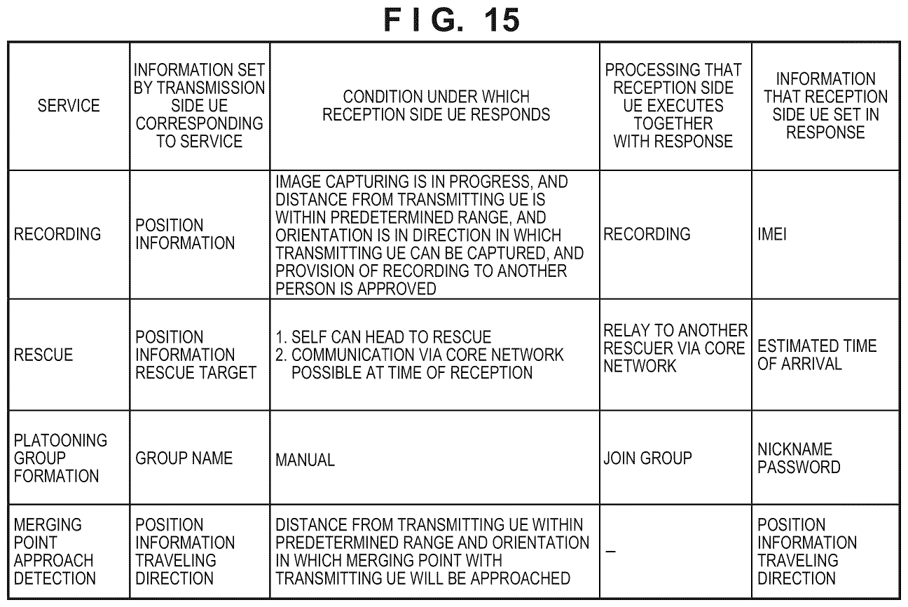

FIG. 15 shows an example of information set in the discovery message. Note that in the example shown in FIG. 15, examples of a value representing a service settable in the Service field include recording, rescue, platooning group formation, and merging point approach detection. Information that is set by a first UE on the transmission side of the discovery message in a case where each of these services is stored in the Service field will be described below. Furthermore, a condition for responding to the message, processing to be executed together with the response, and information set in the response message by a second UE on the reception side will also be described. Note that the service contents are not limited to the above-described four services, and a value representing a service other than these services may be set in the Service field. For example, the above-described four services are services in a case where the UE is mounted on a vehicle, and a service in a case where no UE is mounted on a vehicle may be defined. In addition, the information stored in the discovery message, the condition for responding in the UE on the reception side, the processing to be executed, and the information included in the response message are not limited to the examples shown in FIG. 15. That is, for example, even if the service is “recording”, the contents are different from those shown in FIG. 15 and to be described later.

First, a case where “recording” is set in the Service field will be described. In this case, the first UE on the transmission side of the discovery message stores the position information of the self-apparatus (first UE) in the discovery message. Then, for example, if the following four conditions are all satisfied, the second UE on the reception side of the message returns a response message to the first UE. The first condition is that the second UE is executing image capturing using the image capturing function of the self-apparatus (second UE) at the time of receiving the discovery message. This is the condition that when a phenomenon such as a traffic accident occurs, the phenomenon may be captured. That is, in a case where the discovery message is transmitted after the occurrence of such phenomenon, if the second UE does not execute image capturing at this time, it is assumed that the second UE does not capture a video that is desired to be recorded. Therefore, if the second UE does not execute image capturing at the time of receiving the discovery message, it transmits no response message to the first UE. The second condition is that the second UE exists in a region where the distance from the first UE falls within a predetermined range. The communicable distance of sidelink communication between the UEs is, for example, about 500 meters. Therefore, the predetermined range can be set to be equal to the communicable distance or less. In a case like the recording service, for example, an image captured by the second UE that exists at a distance close to the side (the position where the first UE exists) is useful to specify the situation. Therefore, if the second UE is far away from the first UE and is thus estimated not to be able to execute useful image capturing, the second UE transmits no response message to the first UE. The above-described predetermined range can be set so as to obtain such useful image. Note that the predetermined range may be a fixed value or a dynamically settable value. The third condition is that the self-apparatus (second UE) is in such posture that it can capture, by the image capturing function of the self-apparatus, the position of the UE (first UE) which has transmitted the discovery message. That is, if, for example, the second UE is in such posture that it cannot capture a recording target such as an accident site, even if the distance from the first UE is sufficiently close, the second UE transmits no response message to the first UE. The fourth condition is that the second UE permits provision of a recorded video to a third party. Since a recorded video such as a captured image of a drive recorder is owned by the image capturing person, the video must not be given to a third party without the permission of the owner. Thus, if the second UE does not permit provision of a recorded video to a third party, it transmits no response message to the first UE. The second UE that satisfies the above-described first to fourth conditions can transmit the response message to the first UE.

If the second UE decides to transmit the response message, it stores a video captured by the image capturing function of the self-apparatus (it does not discard the video for at least a predetermined period). Furthermore, the second UE transmits, to the first UE, the response message including identification information used for sidelink communication, such as International Mobile Equipment Identity (IMEI). After that, by setting the IMEI as a destination, the first UE can thus request a communication apparatus, that records the video, to transmit the video.

A case where “rescue” is set in the Service field will be described next. In this case, the first UE stores the position information of the self-apparatus and a rescue target requested by the self-apparatus in the discovery message, and transmits the discovery message. For example, information indicating a necessary rescue such as “failure”, “out of gasoline”, “distress”, or “tailgater approaching” is stored as information of the rescue target in the discovery message. In an example, information of “failure” may be information indicating a more detailed rescue target such as “engine failure” or “flat tire”. The second UE transmits the response message to the discovery message under the condition that the self-apparatus can go to rescue or that the self-apparatus can perform communication via a core network at the time of receiving the discovery message. Note that if the second UE transmits the response message because the self-apparatus can go to rescue, it goes to the position of the first UE without performing any processing in the apparatus. Note that in this case, the second UE can transmit the response message including information of an estimated time at which the self-apparatus will arrive at the position of the first UE. On the other hand, if the second UE transmits the response message because the self-apparatus can perform communication via the core network, it performs Relay communication to another rescuer via the core network. In this case, the second UE can transfer, to the first UE, the response message generated by the other rescuer without transmitting the response message generated by the self-apparatus. This response message can include information of an estimated time at which the other rescuer will arrive at the position of the first UE.

Subsequently, a case where “platooning group formation” is set in the Service field will be described. In this case, a group name as an identifier for forming a platoon is set in the discovery message. The second UE can decide whether to transmit the response message, by a manual operation by the user. If the second UE transmits the response message, it transmits, to the first UE, the response message including the identifier of the self-apparatus and a password for joining the group. The second UE can use, for example, the nickname of the self-apparatus as the identifier. The first UE can obtain the password and the identifier associated with the second UE by receiving the response message, and determines whether to allow the second UE to join the group. A plurality of vehicles including the UEs belonging to the thus formed group can be controlled to perform automatic platooning using, for example, a known automated driving technique.

Finally, a case where “merging point approach detection” is set in the Service field will be described. In this case, the discovery message includes the position information of the first UE and information indicating the traveling direction. If the distance from the first UE falls within the predetermined range and the second UE travels in a direction in which it will approach the first UE at the merging point, the second UE transmits the response message. In an example, the second UE does not perform any processing other than transmission of the response message. The second UE transmits, to the first UE, the response message including the position information of the self-apparatus (second UE) and the information indicating the traveling direction. Thus, the first UE can detect that it approaches the second UE at the merging point in the advancing direction of the self-apparatus.

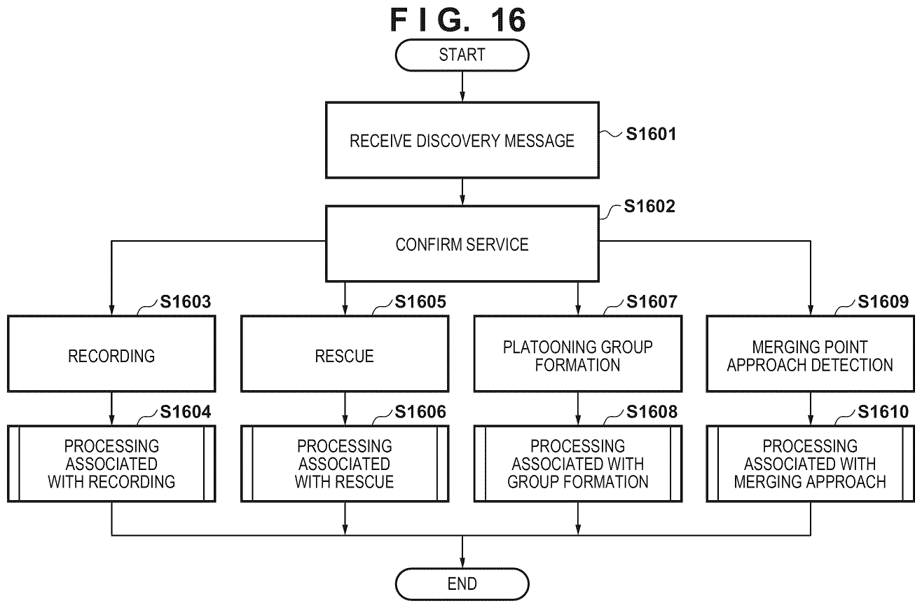

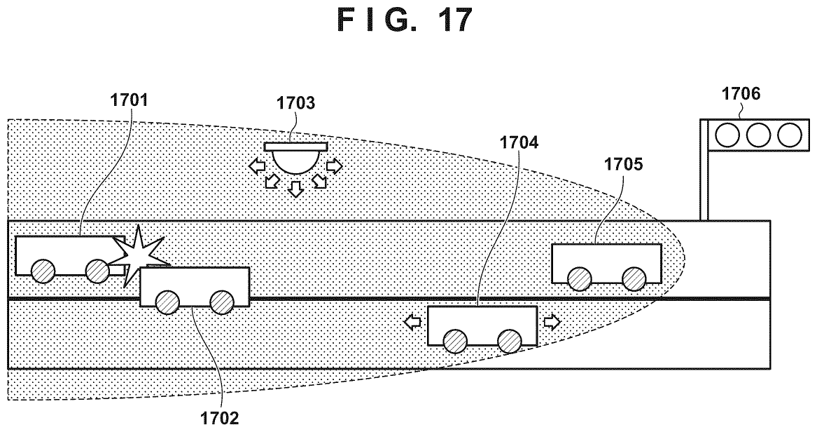

FIG. 16 shows an example of the procedure of processing executed by the second UE on the reception side of a discovery message according to this embodiment. Upon receiving a discovery message sent from another UE (step S1601), the second UE confirms a service included in the discovery message (step S1602). If “recording” is set in the Service field of the discovery message (step S1603), the second UE executes processing associated with “recording” (step S1604). On the other hand, if “rescue” is set in the Service field of the discovery message (step S1605), the second UE executes processing associated with “rescue” (step S1606). Alternatively, if “platooning group formation” is set in the Service field of the discovery message (step S1607), the second UE executes processing associated with “platooning group formation” (step S1608). If “merging point approach detection” is set in the Service field of the discovery message (step S1609), the second UE executes processing associated with “merging point approach detection” (step S1610). Note that the processing associated with each service is as described above, and a repetitive description will be omitted.

A use case of a system will be described with reference to FIG. 17. In this example, a vehicle 1701, a vehicle 1702, a network camera 1703, a vehicle 1704, a vehicle 1705, and a Road Side Unit (RSU 1706) exist within a predetermined range. A situation is considered in which the vehicles 1701 and 1702 collide and the UE mounted on the vehicle 1701 requests other UEs on the periphery to provide captured images. In this case, the UE mounted on the vehicle 1701 transmits a discovery message. This UE will simply be referred to as “vehicle 1701” hereinafter. Similarly, the vehicle 1702, the network camera 1703, the vehicle 1704, the vehicle 1705, and the RUS 1706 indicate the UEs in these apparatuses, respectively. The vehicle 1701 sets “recording” in the Service field of the discovery message, and sets the position information of the vehicle 1701 as information corresponding to the service in the Frame Payload field. Note that the vehicle 1702 also performs the above-described processing, which is the same as that performed by the vehicle 1701. Therefore, only the vehicle 1701 will be described and a description of the vehicle 1702 will be omitted.

Assume that the vehicle 1702 has the image capturing function, and can capture a video only in the traveling direction, but does not permit provision of the recorded video. Note that in FIG. 17, an arrow indicates an image capturing direction. Assume that the network camera 1703 has the image capturing function, can record videos in all directions (at least the entire region in a lane on which the vehicle 1701 and the like travel), and permits provision of the recorded videos. Assume that the vehicle 1704 has the image capturing function, can capture videos in the traveling direction and the opposite direction, and permits provision of the recorded videos. Assume that the vehicle 1705 has the image capturing function, can capture a video only in the traveling direction, and permits provision of the recorded video. Assume that the RSU 1706 has no image capturing function.

Assume, for example, that the vehicle 1701 can execute sidelink communication with the vehicle 1702, the network camera 1703, the vehicle 1704, the vehicle 1705, and the RUS 1706. That is, the communicable range of the vehicle 1701 includes the position of the RSU 1706. On the other hand, the vehicle 1701 can set a range different from the communicable range, such as a hatched region shown in FIG. 17, as a range where the vehicle 1701 searches for other UEs using the discovery message. FIG. 17 shows a situation in which the vehicle 1701 sets, as a search range, a range that includes positions where the vehicle 1702, the network camera 1703, the vehicle 1704, and the vehicle 1705 exist, respectively, but does not include the position of the RUS 1706.

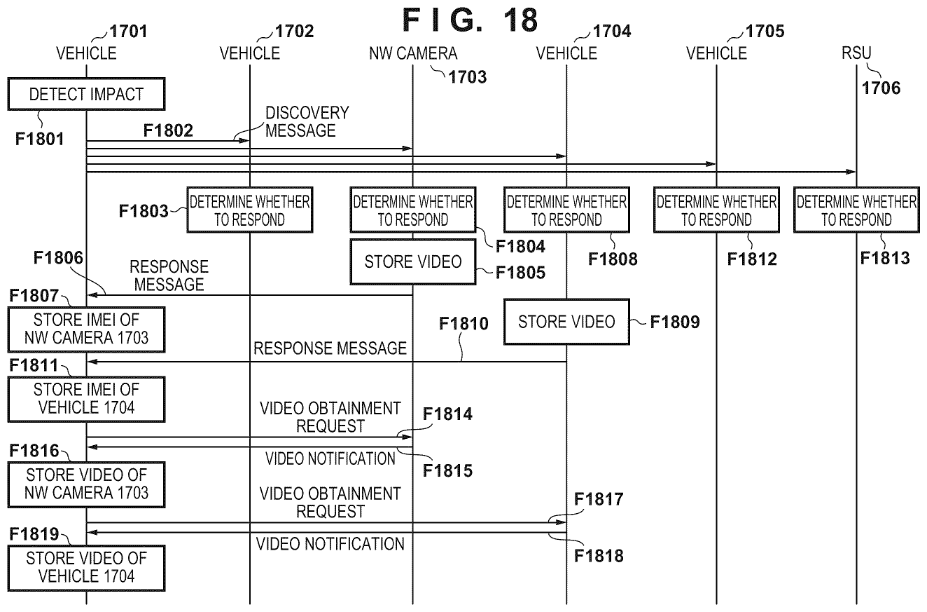

FIG. 18 shows an example of an operation executed in the system in the situation shown in FIG. 17. Note that FIG. 18 shows an operation example in a case where the vehicle 1701 transmits the discovery message for requesting the “recording” service of other UEs on the periphery by using a collision with the vehicle 1702 as a trigger.

First, upon detecting an impact of a predetermined level or higher (F1801), the vehicle 1701 generates a discovery message by setting “recording” in the Service field and storing the position information of the self-apparatus in the Frame Payload field, and sends the discovery message to the periphery (F1802). Note that the position information of the vehicle 1701 can be obtained using, for example, the GPS function mounted on the vehicle 1701. Each of the vehicle 1702, the network camera 1703, the vehicle 1704, the vehicle 1705, and the RSU 1706 receives the discovery message, and specifies that “recording” is set in the Service field. Then, each of the vehicle 1702, the network camera 1703, the vehicle 1704, the vehicle 1705, and the RSU 1706 decides whether to transmit a response message to the discovery message.

The vehicle 1702 performs image capturing in the self-apparatus but does not permit provision of a video. Therefore, the vehicle 1702 decides not to transmit a response message (F1803), and directly ends the processing.

Since the network camera 1703 is performing image capturing in the direction of the vehicle 1701, is at a distance from the vehicle 1701, which falls within the predetermined range, and permits provision of a video, it decides to return a response message (F1804). In this case, the network camera 1703 stores the captured video (F1805), and returns the response message including the IMEI of the self-apparatus to the vehicle 1701 (F1806). Then, the vehicle 1701 stores the IMEI of the network camera 1703 in order to obtain the video from the network camera 1703 thereafter (F1807). Similarly, the vehicle 1704 also decides to return a response message (F1808), stores a captured video (F1809), and returns the response message including the IMEI of the self-apparatus to the vehicle 1701 (F1810). Then, the vehicle 1701 stores the IMEI of the vehicle 1704 (F1811).

The vehicle 1705 is performing image capturing in the self-apparatus, permits provision of a video, and is at a distance from the vehicle 1701, which falls within the predetermined range, but does not perform image capturing in the direction of the vehicle 1701. Therefore, the vehicle 1705 decides not to transmit a response message (F1812), and directly ends the processing.

The RSU 1706 has no image capturing function, and is at a distance from the vehicle 1701, which falls outside the predetermined range. Therefore, the RSU 1706 decides not to transmit a response message (F1813), and directly ends the processing.

After that, the vehicle 1701 sets, as a destination, the IMEI of the network camera 1703 stored in F1807, and requests the network camera 1703 to transmit the stored video (F1814). Upon receiving the request message from the vehicle 1701, the network camera 1703 transmits the video stored in F1805 to the vehicle 1701 (F1815). Upon receiving the video from the network camera 1703, the vehicle 1701 stores the video (F1816). Furthermore, the vehicle 1701 sets, as a destination, the IMEI of the vehicle 1704 stored in F1811, and requests the vehicle 1704 to transmit the stored video (F1817). Upon receiving the request message from the vehicle 1701, the vehicle 1704 transmits the video stored in F1809 to the vehicle 1701 (F1818). Upon receiving the video from the vehicle 1704, the vehicle 1701 stores the video (F1819).

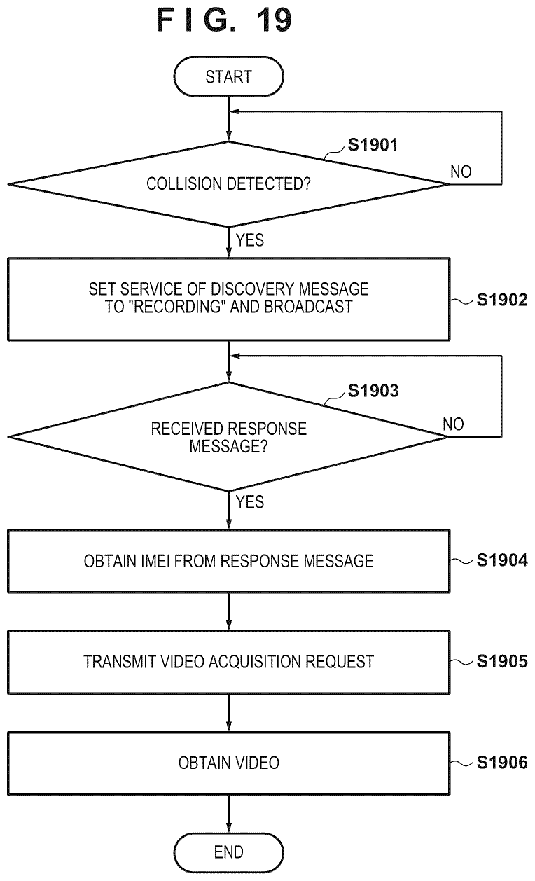

Subsequently, an example of the procedure of processing executed by the UE on the request side of the “recording” service like the UE mounted on the vehicle 1701 will be described with reference to FIG. 19. Note that the UE on the request side of the “recording” service will sometimes be referred to as the first UE hereinafter, and the UE on the request reception side of the “recording service” will sometimes be referred to as the second UE hereinafter.

First, the first UE monitors whether an impact (collision) of a predetermined level or higher occurs (step S1901). Note that this monitoring operation is performed to determine a transmission trigger of a discovery message for requesting the service. If another trigger is used, state monitoring corresponding to the trigger or the like can be performed. For example, if a discovery message is transmitted when a predetermined user operation is accepted, the first UE can monitor whether the predetermined user operation is accepted. For example, when another vehicle that dangerously drives exists on the periphery of the vehicle 1701, if a user operation for requesting vehicles on the periphery to perform recording is performed, a discovery message may be transmitted. Upon detecting a transmission trigger (in this example, a collision) of a discovery message (YES in step S1901), the first UE generates a discovery message in which the requested service (in this example, “recording”) is set, and broadcasts the discovery message (step S1902). Then, the first UE waits for reception of a response message from another UE on the periphery (step S1903). Note that the first UE may transmit the discovery message, for example, a plurality of times in every predetermined cycle, or may retransmit the discovery message if a response message is not received for a predetermined period. Alternatively, if a response message is not received for a predetermined period, the first UE may end the processing.

Upon receiving the response message (YES in step S1903), the first UE obtains and stores the IMEI of the second UE as the transmission source of the response message, which is included in the response message (step S1904). After that, the first UE sets the stored IMEI as a destination to request the second UE to provide the stored video (step S1905), and obtains the video from the second UE (step S1906).

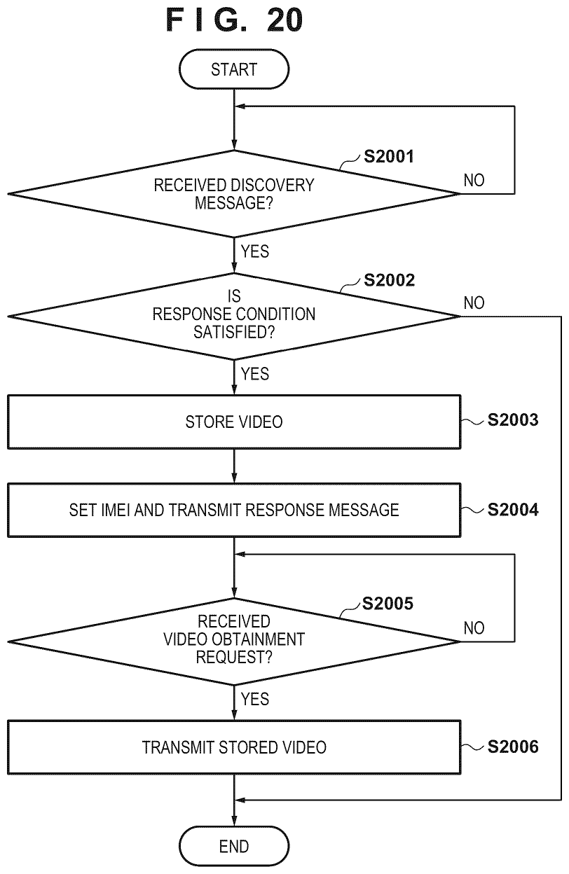

Next, an example of the procedure of processing executed by the UE on the request reception side of the “recording” service like the UEs respectively mounted on the vehicle 1702, the network camera 1703, the vehicle 1704, the vehicle 1705, and the RSU 1706 will be described with reference to FIG. 20. In this example as well, the UE on the request side of the “recording” service will sometimes be referred to as the first UE hereinafter, and the UE on the request reception side of the “recording service” will sometimes be referred to as the second UE hereinafter. Note that the first UE that executes the processing shown in FIG. 19 can execute the processing shown in FIG. 20 in parallel, as a matter of course. Similarly, the second UE that executes the processing shown in FIG. 20 can execute the processing shown in FIG. 19 in parallel. That is, the UE can function as one of the first UE and the second UE in accordance with the status of the self-apparatus.

Upon receiving the discovery message from the first UE (YES in step S2001), the second UE determines whether to respond to the discovery message (step S2002). That is, for example, the second UE determines whether the conditions for responding to the discovery message, which have been described with reference to FIG. 15, are satisfied. If it is determined that the conditions are not satisfied (NO in step S2002), the second UE directly ends the processing without transmitting a response message. For example, since each of the vehicle 1702, the vehicle 1705, and the RSU 1706 does not satisfy the conditions, as described above, it transmits no response message. On the other hand, if it is determined that the conditions are satisfied (YES in step S2002), the second UE stores the video (step S2003), generates a response message including the IMEI of the self-apparatus, and transmits the response message to the first UE (step S2004). For example, since each of the network camera 1703 and the vehicle 1704 satisfies the conditions, as described above, it stores the video, and transmits a response message. If the second UE receives a video obtainment request, for which the IMEI of the self-apparatus is set as a destination, from the first UE after transmitting the response message (YES in step S2005), the second UE transmits the video stored in step S2003 to the first UE (step S2006). Note that if, for example, the second UE does not receive a video obtainment request for a predetermined period (NO in step S2005), the second UE may delete the video stored in step S2003, and end the processing.

As described above, by using sidelink communication, the vehicle 1701 can request, in response to, for example, detection of a collision, another UE on its periphery to store and provide a video, and obtain the stored video.

Note that the above-described operation example is associated with “recording”. However, for example, the processes in steps S1606, S1608, and S1610 of FIG. 16 are executed in accordance with the table shown in FIG. 15. For example, in addition to or instead of “recording” described above, the vehicle 1701 can send a discovery message in which “rescue” is set. In this case, for example, the vehicle 1705 travels in a direction away from the vehicle 1701, and thus cannot go to rescue. Therefore, for example, the vehicle 1705 can be prevented from transmitting a response message in a case where it cannot perform communication via the core network. Each of the network camera 1703 and the RSU 1706 cannot rescue, but relays the discovery message to another rescuer in a case where it can execute communication via the core network. In an example, each of the network camera 1703 and the RSU 1706 can transmit the discovery message to a contact such as the police. Then, each of the network camera 1703 and the RSU 1706 can transfer a response message from the other rescuer to the vehicle 1701. In this case, in the response message, an estimated time of arrival of the other rescuer can be set. Since the vehicle 1704 travels in a direction of approaching the vehicle 1701, it can go to rescue. Therefore, for example, the vehicle 1704 can transmit a response message in which an estimated time of arrival is set based on the distance from the vehicle 1701. Note that since the vehicle 1702 is the party involved in the collision, it cannot go to rescue and thus transmits no response message.

If a discovery message in which “platooning group formation” is set is transmitted, the vehicle that has received the discovery message notifies a driver that the message has been received. If the vehicle accepts approval of forming a platooning group from the driver, it can notify the vehicle as the transmission source of the discovery message of a response message. Alternatively, if a discovery message in which “merging point approach detection” is set is transmitted, another vehicle approaching the merging point transmits a response message including the position information of the self-apparatus and the traveling direction.

As described above, by using a sidelink discovery message and a response message to it, it is possible to appropriately provide a service, requested by the UE on the transmission side of the discovery message, to the UE.

### Third Embodiment

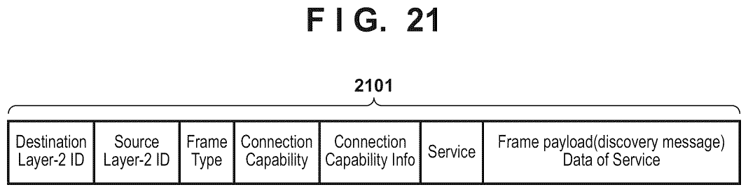

The above-described first and second embodiments may be combined. For example, as shown in FIG. 21, a discovery message 2101 can be formed. The discovery message 2101 is obtained by adding a “Service” field described with reference to FIG. 14 immediately after “Connection Capability Info” in a discovery message shown in FIG. 4. Note that the order of these fields is not limited to this, and a field such as a Connection Capability field may be arranged after the Service field. In addition, information corresponding to the Service field is stored in a Frame Payload field shown in FIG. 4.

By using this structure, for example, the first UE on the transmission side of the discovery message can execute D2D communication, and specify the second UE that can execute “Service”. For example, in FIG. 17, in response to detection of an impact of a predetermined level or higher, a vehicle 1701 searches for another UE that can execute D2D communication as in the first embodiment, and searches for another UE that supports the “recording” service as in the second embodiment. That is, the vehicle 1701 sends the discovery message in which the bit corresponding to D2D communication in the Connection Capability field is set to 1 and “recording” is set in the Service field. Furthermore, the vehicle 1701 sets information (in this case, the position information) corresponding to the service in the Frame Payload field. Upon receiving the discovery message, another UE on the periphery transmits a response message in a case where it supports D2D communication and satisfies the conditions associated with the “recording” service. If, for example, a vehicle 1704 shown in FIG. 17 does not support D2D communication, the vehicle 1704 can be prevented from transmitting a response message although the conditions associated with the recording service are satisfied. In this manner, the first UE can discover the second UE that can request and obtain a video by D2D communication thereafter. Note that if all of a vehicle 1702, a network camera 1703, the vehicle 1704, a vehicle 1705, and an RSU 1706 satisfy D2D communication, the same operation as that described in the second embodiment is performed.

Note that this is merely an example, and various forms are possible. For example, if the discovery message in which the “rescue” service is set is transmitted, the UE that satisfies the condition that communication via the core network is possible can be caused to transmit a response message in a case where Network Relay is also possible. That is, the UE that can execute communication via the core network but cannot execute Network Relay can be prevented from transmitting a response message. On the other hand, the UE that can go to rescue can be caused to transmit a response message even if it cannot execute Network Relay. In this way, in accordance with a combination of the satisfied condition associated with the service and the supported sidelink communication method, it may be decided whether to transmit a response message.

The above-described embodiments can arbitrarily be used in combination unless otherwise specified.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

1. A communication apparatus comprising:
a communication unit configured to perform communication using a sidelink communication function in a 3rd Generation Partnership Project (3GPP) standard; and
a search unit configured to search, by transmitting a discovery message including information indicating a predetermined function performed using the sidelink communication function, for another communication apparatus that can execute the predetermined function after the apparatuses are connected for the sidelink communication function.

2. The communication apparatus according to claim 1, wherein
the information indicating the predetermined function is information indicating a communication method supported by the communication apparatus, and
the search unit searches for the other communication apparatus that can execute the predetermined function, based on a response that is transmitted by the other communication apparatus in a case where the other communication apparatus that supports the communication method receives the discovery message.

3. The communication apparatus according to claim 2, wherein the information indicating the communication method is information indicating a communication method requested by the communication apparatus to be used for communication with another communication apparatus, among a plurality of communication methods supported by the communication apparatus.

4. The communication apparatus according to claim 3, wherein the plurality of communication methods include a first communication method of performing direct communication between the communication apparatus and the other communication apparatus, a second communication method of relaying communication between the communication apparatus and a communication partner of the communication apparatus having a sidelink communication function, and a third communication method of relaying communication between the communication apparatus and a base station.

5. The communication apparatus according to claim 1, wherein
the information indicating the predetermined function includes information indicating a service requested by the communication apparatus to be executed by another apparatus, and
the search unit searches for the other communication apparatus that can execute the predetermined function, based on a response that is transmitted by the other communication apparatus in a case where the other communication apparatus that satisfies a condition corresponding to the service receives the discovery message.

6. The communication apparatus according to claim 5, wherein
the communication apparatus is a vehicle, and
the information indicating the service includes at least one of a service for recording and providing information captured by the other apparatus, a service for rescuing the vehicle, a service for forming a group for platooning with the vehicle, and a service for detecting a merging point which the vehicle approaches.

7. The communication apparatus according to claim 6, wherein in a case where the information indicating the service indicates the service for recording and providing the information captured by the other apparatus, the discovery message further includes position information of the communication apparatus.

8. The communication apparatus according to claim 7, wherein in a case where the information indicating the service indicates the service for recording and providing the information captured by the other apparatus, the communication unit obtains an identification number of the other communication apparatus from the response, and performs, by using the identification number, communication for obtaining the information captured by the other communication apparatus.

9. The communication apparatus according to claim 6, wherein in a case where the information indicating the service indicates the service for rescuing the vehicle, the discovery message further includes position information of the communication apparatus and information indicating a requested rescue.

10. The communication apparatus according to claim 6, wherein in a case where the information indicating the service indicates the service for forming the group for platooning with the vehicle, the discovery message further includes information indicating a group name.

11. A communication apparatus comprising:
a communication unit configured to perform communication with another communication apparatus using a sidelink communication function in a 3rd Generation Partnership Project (3GPP) standard;
a transmission unit configured to transmit a discovery message including information related to relay communication in order to search a relay apparatus that relays communication with the other communication apparatus;
a receiving unit configured to receive, after transmission of the discovery message, a response message from the relay apparatus; and
a connection processing unit configured to connect to the relay apparatus.

12. The communication apparatus according to claim 11, wherein the discovery message includes an identifier of the communication apparatus and an identifier of the other communication apparatus.

13. The communication apparatus according to claim 11, wherein the response message includes an identifier of the other communication apparatus.

14. The communication apparatus according to claim 11, further comprising a selection unit configured to select, in a case where the response message is received from a plurality of relay apparatuses, one relay apparatus from among the plurality of relay apparatuses.

15. A control method executed by a communication apparatus that performs communication using a sidelink communication function in a 3rd Generation Partnership Project (3GPP) standard, comprising:
searching, by transmitting a discovery message including information indicating a predetermined function performed using the sidelink communication function, for another communication apparatus that can execute the predetermined function after the apparatuses are connected for the sidelink communication function.

16. A non-transitory computer-readable storage medium that stores a program for causing a computer included in a communication apparatus that performs communication using a sidelink communication function in a 3rd Generation Partnership Project (3GPP) standard to:
search, by transmitting a discovery message including information indicating a predetermined function performed using the sidelink communication function, for another communication apparatus that can execute the predetermined function after the apparatuses are connected for the sidelink communication function.
